(19) United States
(12) Patent Application Publication
(10) Pub. No.: US 2025/0198441 A1
(43) Pub. Date: Jun. 19, 2025

(54) JOINERY PRODUCT COMPRISING A LOCKING DEVICE

(71) Applicant: Välinge Innovation AB, Viken (SE)

(72) Inventor: Thomas MEIJER, VIKEN (SE)

(73) Assignee: Välinge Innovation AB, Viken (SE)

(21) Appl. No.: 18/983,417

(22) Filed: Dec. 17, 2024

(30) Foreign Application Priority Data
Dec. 18, 2023 (SE) 2351445-8

(51) Int. Cl. F16B 12/10; A47B 88/90; A47B 88/95

(52) U.S. Cl. CPC F16B 12/10; A47B 88/95; A47B 2088/902; A47B 88/941

(57) ABSTRACT

A joinery product including a first joinery element, a second joinery element, and a third joinery element, which are interlocked by means of a mechanical locking device including a dowel, an insertion recess configured to receive the dowel to counteract displacement of the first joinery element relative to the second joinery element in a first direction, a compressible locking element, a locking recess configured to receive the compressible locking element to counteract displacement of the first joinery element relative to the second joinery element in a second direction, and a locking means configured to counteract rotational displacement of the first joinery element relative to the second joinery element.

### CROSS REFERENCE TO RELATED APPLICATIONS

The present application claims the benefit of Swedish Application No. 2351445-8, filed on Dec. 18, 2023. The entire contents of Swedish Application No. 2351445-8 are hereby incorporated herein by reference in their entirety.

### TECHNICAL FIELD

Embodiments of the disclosure relate to joinery elements configured to be locked together with a mechanical locking device to form a joinery product. The joinery product may be a furniture component such as a bookshelf, a cupboard, a wardrobe, a box, a drawer or another furniture component and the joinery product may thereafter be dismantled.

### BACKGROUND

Conventionally, furniture components such as drawers, cupboards, and similar pieces may be assembled to by means of screws. Lately, however, this technology has been developed in a number of directions without the need for screws.

A furniture product provided with a mechanical locking element is known in the art, e.g., by WO 2015/038059. The furniture product comprises a first panel connected to a second panel by a mechanical locking element comprising a rod-shaped element, an insertion groove, a locking groove, and a locking element.

There is a need for a locking device for a joinery product of joinery elements with an improved locking.

### SUMMARY

It is an object of at least embodiments of the present disclosure to provide an improvement over the above described techniques and known art.

Another object of at least embodiments of the present disclosure is to provide a locking device which facilitates the production of a joinery product, and which facilitates dismantling of the joinery product.

Previously, it is known to assemble joinery products such as furniture or parts of furniture, by means of a compressible locking element and two or more dowels. In order to make the joinery product stable, the compressible locking element is used to prevent the assembly elements to move in relation to each other in one plane. The dowels are configured to prevent the assembly elements to move in a direction normal to said plane. Further, the dowels also prevent rotation of the assembly elements in relation to each other, by providing two attachment points spatially separate from each other.

In some joinery products, there is limited space for arranging the compressible locking element and the at least two dowels. This is especially valid for joinery products such as shallow drawers, such as, e.g., variants of kitchen drawers. Drawers designed to house, e.g. cutlery are often shallow in order for a user to easily get a view of the content accommodated in the drawer. It may be difficult to arrange a mechanical locking system in such a shallow drawer and at the same time achieve a stable joinery product which is able to withstand demanding environments and high usage such as in a kitchen. There is thus a need for an improved joinery product.

In one aspect, a joinery product is provided. The joinery product comprises a first joinery element having a first edge surface, a second edge surface, and a first joinery element surface. Said second edge surface is adjacent to said first edge surface and a first attaching surface is at least part of said first edge surface or said second edge surface.

The joinery product further comprises a second joinery element having a second joinery element surface, a third joinery element surface, a third edge surface, and a fourth edge surface. A second attaching surface is at least part of said second joinery element surface, the third edge surface or the fourth edge surface. The first attaching surface faces and is configured to be locked with the second attaching surface.

The joinery product further comprises a third joinery element positioned in a joinery element groove formed in the surface which comprises the second attaching surface and a thereto adjacent surface of the first joinery element.

The joinery product further comprises a mechanical locking device comprising a dowel protruding at a dowel angle from the first attaching surface and an insertion recess extending into the second attaching surface. The insertion recess is configured to receive said dowel.

The mechanical locking device further comprises a compressible locking element, positioned partially in a first joinery element recess in the first attaching surface, and a locking recess in the second attaching surface configured to receive said compressible locking element.

A locking surface of said locking recess is configured, in the locked position, to cooperate with the compressible locking element for locking of the first joinery element relative to the second joinery element in directions in the plane of the first attaching surface.

The inclination of said dowel counteracts displacement of the first joinery element relative to the second joinery element along the normal direction of the first attaching surface.

The mechanical locking device further comprises a locking member arranged in the joinery element groove. The third joinery element is locked in the joinery element groove by the locking members to counteract rotational displacement of the first joinery element relative to the second joinery element in directions in the plane of the first attaching surface.

The first, second, and third joinery elements of this joinery product are locked to each other by mechanical the locking device. Components of the mechanical locking device interact such that the joinery elements are locked in three dimensions.

Known locking systems use two or more dowels in order to prevent rotation of two adjacent joinery elements in relation to each other. In a shallow joinery product, such as a shallow drawer, there may be no space available to accommodate at least two dowels. The present disclosure makes use of a locking member serving to lock a third joinery element in relation to the first and second joinery elements. Thus, rotation of the first and second joinery elements may be prevented due to the interlock with the third joinery element. The one or more dowels which are not required with the present solution are replaced by the locking means which locks the third joinery element.

This provides for a possibility to produce stable, durable shallow joinery products. This is especially advantageous for, e.g., kitchen drawers which are subject to high wear and may be exposed to demanding environments.

In one embodiment, the locking device comprises two locking members.

In one embodiment, the locking device comprises more than two locking members.

In one embodiment, the third joinery element interacts with interior surfaces of the joinery element grooves to counteract rotational displacement of the first joinery element relative to the second joinery element in directions in the plane of the first attaching surface. In this embodiment, the locking means may not be required. Instead, the third joinery element may be locked in the joinery element groove by means of friction or by means of complementary shapes of the groove versus the third joinery element.

In one embodiment, the joinery element groove comprises a locking member groove configured to house a locking member. This may provide for a secure positioning of the locking member. The locking member groove may have the same longitudinal extent as the joinery element groove. This may provide for the locking member to be longitudinally adjustable within the locking member groove.

In one embodiment, the locking member groove may be provided along parts of the extent of the joinery element groove.

In one embodiment, the length of the locking member groove may correspond approximately to the length of the locking member. This may facilitate placement of the locking member.

In one embodiment, the locking member is an elongate flexible tongue. The elongate shape of the flexible tongue means that it may require less installation space compared to other types of locking member, such as round or semi-round, locking member such as a locking member comprising a cam surface.

In one embodiment, the locking member is arranged in a locking member groove provided in the joinery element groove.

The flexible tongue is configured to exert a pressure on the third joinery element against the joinery element groove. The flexible tongue may be configured to flex into the locking member groove when the third joinery element is inserted into the joinery element groove. Once the third joinery element is arranged in the joinery element groove, the flexible tongue may be configured to flex back, partially out of the locking member groove, pressing against the third joinery element, which thus may be pressed against a side surface of the joinery element groove. The elongate flexible tongue may be advantageous in that it may exert a pressure distributed over a larger surface or distributed over a larger longitudinal extent of the third joinery element. Thus, the locking may be improved compared to single point locking methods, or locking methods not having as large longitudinal extents.

The elongate locking tongue may be advantageous in that its design may provide a maintained constant locking force over time.

In one embodiment, the flexible tongue may be fixed into the locking member groove with glue. In one embodiment, the flexible tongue may be fixed into the locking member groove with a friction connection. In one embodiment, the friction connection may comprise a protrusion arranged at the upper surface and/or at the lower surface of the tongue.

In one embodiment, the mechanical locking device may comprise only one dowel at the first attaching surface. This is especially advantageous for shallow joinery products, where there may not be room to accommodate several dowels in order to stabilize the adjacent joinery elements against each other.

In one embodiment, the compressible locking element may be arranged proximal the third joinery element compared to the dowel.

In one embodiment, the dowel may be arranged distal the third joinery element compared to the compressible locking element.

In a joinery product comprising only one dowel, it may be advantageous to arrange the compressible locking element closest to the third joinery element, and thus the dowel remote from the third joinery element. Since the dowel prevents displacement of the first joinery element relative to the second joinery element along the normal direction of the first attaching surface, this placement of the dowel may counteract or prevent a gap forming between the first and second joinery elements at a location distal from an attachment point of the third joinery element.

In one embodiment, the compressible locking element in an uncompressed state partially protrudes from the first attaching surface. The protruding portion of the compressible locking element may be configured to be received by the locking recess, in order to lock the first and second joinery elements to each other.

In one embodiment, the compressible locking element, in a compressed state, is configured to be substantially accommodated within the first joinery element recess.

In one embodiment, the compressible locking element is, in the locked position, configured to be displaced partly into the locking recess.

The compressible looking element may be configured to be compressed into the first joinery element recess during assembly of the first and second joinery elements. When the first and second joinery elements are correctly positioned in relation to each other, the compressible locking element may be configured to decompress/expand partially out of the first joinery element recess and partially into the locking recess.

In one embodiment, said compressible locking element and said dowel are positioned on a straight line extending in the longitudinal extent of the first attaching surface.

In one embodiment, said compressible locking element and said dowel are arranged at different perpendicular distances from a straight line extending in the longitudinal extent of the first attaching surface. The respective distance from the straight line may be less than 30 mm, such as less than 20 mm, such as less than 10 mm, such as less than 5 mm. The placement of the dowel and the compressible locking element may improve the interlock between the first and second joinery element which may improve the stability of the joinery product.

In one embodiment, the dowel angle of the dowel relative the first attaching surface is in a range of 20°-75°, such as in a range of 35°-55°, such as in a range of 40°-50°, such as about 45°. The dowel angle may improve the interlock between the first and second joinery element which may improve the stability of the joinery product.

In one embodiment, said insertion recess extends into the second attaching surface at a recess angle from the second attaching surface and the difference between the dowel angle and the recess angle is in a range of 0° to 6°, such as in a range of 1° to 5°, such as in a range of 2° to 4°, such as about 3°. The assembly of the first and second joinery elements may be facilitated with a smaller difference between the dowel angle and the recess angle.

In one embodiment, a side of the joinery element recess, being adjacent to the first attaching surface, extends at a joinery element recess angle relative the first attaching surface.

In one embodiment, the joinery element recess angle is in a range of 70°-110°, such as in a range of 80°-100°, such as in a range of 85°-95°, such as about 90°. The assembly of the first and second joinery elements may be facilitated when the joinery element recess angle approaches 90°.

In one embodiment, a difference between the dowel angle and the joinery element recess angle is 10°-100°, such as 20°-70°, such as 30°-60°, such as 40°-50°, such as about 45° or about 42°.

In one embodiment, the locking member has a longitudinal shape with a length direction parallel to a length direction of the joinery element groove. The longitudinal shape of the locking member may distribute the pressure applied onto the third joinery element more evenly.

In one embodiment, the locking member is configured to be compressed towards a bottom surface of the locking member groove. When the locking member is compressed into the locking member groove, the third joinery element may be allowed to enter the joinery element recess. When the third joinery element is accommodated in the joinery element recess, the locking member may be configured to decompress and may exert a pressure onto the third joinery element, pressing it against side surfaces of the joinery element groove.

In one embodiment, the flexible tongue is made of a polymer material.

In one embodiment, the joinery product is one of a cupboard or a drawer, optionally a kitchen drawer. The joinery product may comprise two first joinery elements and two second joinery elements. The joinery product may comprise one locking device arranged in each intersection between a first and a second joinery element. The joinery product may comprise four locking devices in total.

In one embodiment, a height of the joinery product, corresponding to the length of the longer side of the third edge surface, is 30-120 mm, such as 50-100 mm, such as approximately 90 mm. The height of the joinery product may complicate or prevent accommodation of more than one dowel. A joinery product with said height may become stable with a locking device as described above.

In one embodiment, a core material of one or more of the first, second and third joinery elements comprises a wood fibre based board, optionally one of HDF, MDF, plywood, solid wood or particleboard, a reinforced plastic board, and a wood fibre composite board.

In one embodiment, the core material is provided with a decorative layer.

The stability of the joinery product is achieved by the cooperation between each of the compressible locking element, the dowel and the elongate locking member and the first, second and third joinery elements to be locked to each other. Each of the compressible locking element, the dowel and the elongate locking member achieves stability between the joinery elements to be locked in one or more dimension. The result is a stable connection between the joinery elements, resulting in a stable joinery product.

The joinery product may comprise two first elongate joinery elements and two second elongate joinery elements, and one third joinery element. The first joinery elements and second joinery elements may be arranged in a frame-like manner, where the first joinery elements are facing each other, and the second joinery elements are facing each other. The joinery product may further comprise a locking arrangement which may comprise a dowel, a compressible locking element, a dowel locking recess for receiving the dowel in a locked state of the joinery product, and a locking recess for the compressible locking element for receiving the compressible locking element in a locked state of the joinery product. The dowel and the compressible locking element may be arranged in one of the first joinery elements or in one of the second joinery elements. The dowel locking recess, and the locking recess for the compressible locking element may be arranged in the other of the first joinery elements or the second joinery elements.

The locking arrangement may further comprise a joinery element groove. The joinery element groove may be provided in each first joinery element and in each second joinery element. The joinery element groove may be configured to receive the third joinery element. The joinery element groove may be configured to receive a circumferential edge portion of the third joinery element. End portions of the first joinery elements may be attached to respective end portions of the second joinery elements by means of the locking arrangement.

### BRIEF DESCRIPTION OF THE DRAWINGS

The present disclosure will by way of example be described in more detail with reference to the appended schematic drawings, which show embodiments of the present disclosure.

FIGS. 1A-D show different views of a joinery product.

FIG. 2A shows an isometric view of the joinery product provided with a mechanical locking system.

FIG. 2B shows an enlarged portion of FIG. 2A.

FIG. 2C shows an isometric view of the joinery product provided with a mechanical locking system.

FIG. 2D shows an enlarged portion of FIG. 2C.

FIGS. 3A-B show side view cross sections of the joinery product provided with the mechanical locking system.

FIG. 4 shows two joinery elements provided with the mechanical locking system.

FIG. 5 shows a third joinery element inserted in a joinery element groove of the joinery product.

FIGS. 6A-6D show a flexible tongue according to one embodiment.

FIGS. 7A-7E show different views of a flexible tongue according to one embodiment.

FIG. 8 show an enlargement of a cross section A-A of the embodiment shown in FIGS. 7A-7E.

FIGS. 9A-9C show an embodiment of a method to disassemble an embodiment of the present disclosure.

FIGS. 9D-9F show an embodiment of a method to assemble the embodiment shown in FIGS. 9A-9C.

Further, in the figures like reference characters designate like or corresponding parts throughout the several figures.

### DETAILED DESCRIPTION

Specific embodiments of the disclosure now will be described with reference to the accompanying drawings. This disclosure may, however, be embodied in many different forms and should not be construed as limited to the embodiments of the joinery product put forth herein; rather, these embodiments are provided so that this disclosure will be thorough and complete, and will fully convey the scope of the disclosure to those skilled in the art. The terminology used in the detailed description of the embodiments illustrated in the accompanying drawings is not intended to be limiting of the disclosure. In the drawings and in the description, like numbers refer to like elements.

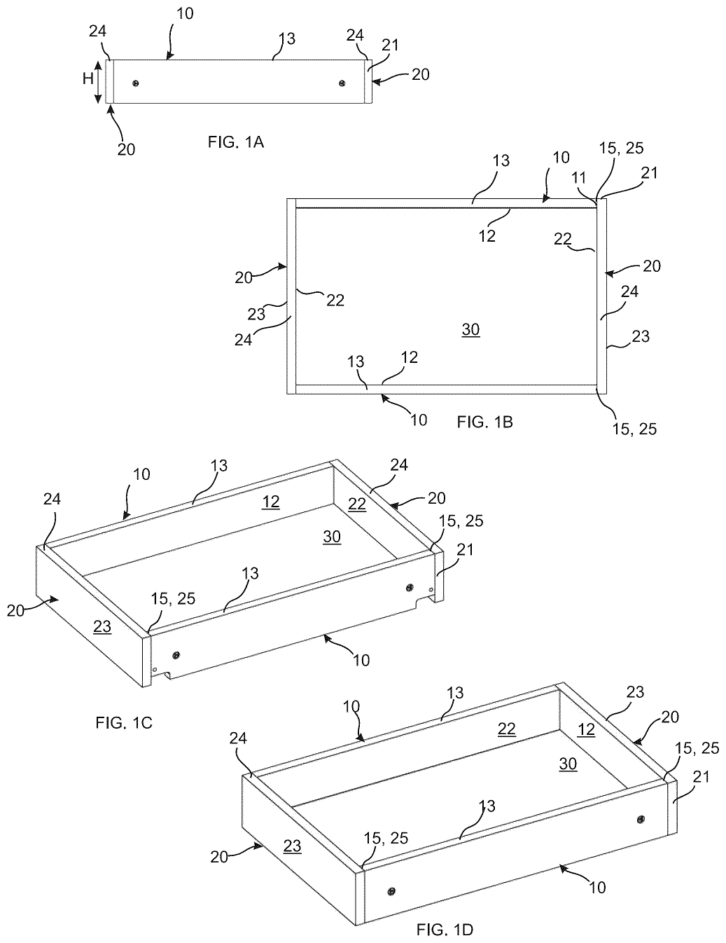

FIGS. 1A-1D show different views of a joinery product according to one embodiment. The joinery product may be a part of a furniture or a furniture component, such as a bookshelf, a cupboard, a wardrobe, a box, a drawer, or a furniture component.

Due to the relatively small height H of the joinery product, there may not be room to accommodate a traditional locking system comprising two dowels. There may not be room for two dowels, or two dowels may end up too close to each other, such that the stability and/or strength of the joinery elements is compromised. Thus, there is a need for an improved locking system suitable for shallow joinery products.

Surfaces described herein extend in two directions, which may be referred to as a first extent and a second extend, which perpendicular to the first extent (or first and second extension direction). They may also be referred to as a longitudinal extent and a thereto perpendicular extent, the longitudinal extent being in the direction of the main extension of the surface.

The joinery product comprises a first joinery element 10, a second joinery element 20, and a third joinery element 30. The first joinery element 10 may have a first main plane, the second joinery element 20 may have a second main plane, and the third joinery element 30 may have a third main plane. The first, second and third main planes are essentially perpendicular to each other when the first 10, second 20, and third 30 joinery elements are assembled to the joinery product.

The joinery product is provided with a mechanical locking system configured to lock the first joinery element 10, the second joinery element 20 and the third joinery element 30 to each other. The mechanical locking device will be further described below.

The first joinery element 10 has a first edge surface 11, a second edge surface 12, and a first joinery element surface 13. The second edge surface 12 is located adjacent to the first edge surface 11. The first joinery element 10 further comprises a first attaching surface 15. The first attaching surface 15 is at least part of said first edge surface 11 or said second edge surface 12.

The second joinery element 20 has a second joinery element surface 22, a third joinery element surface 23, a third edge surface 21, and a fourth edge surface 24. The second joinery element 20 further comprises a second attaching surface 25. The second attaching surface 25 is at least part of said second joinery element surface 22, or the third edge surface 21. In a mounted state of the joinery product, the first attaching surface 15 faces and is configured to be locked with the second attaching surface 25.

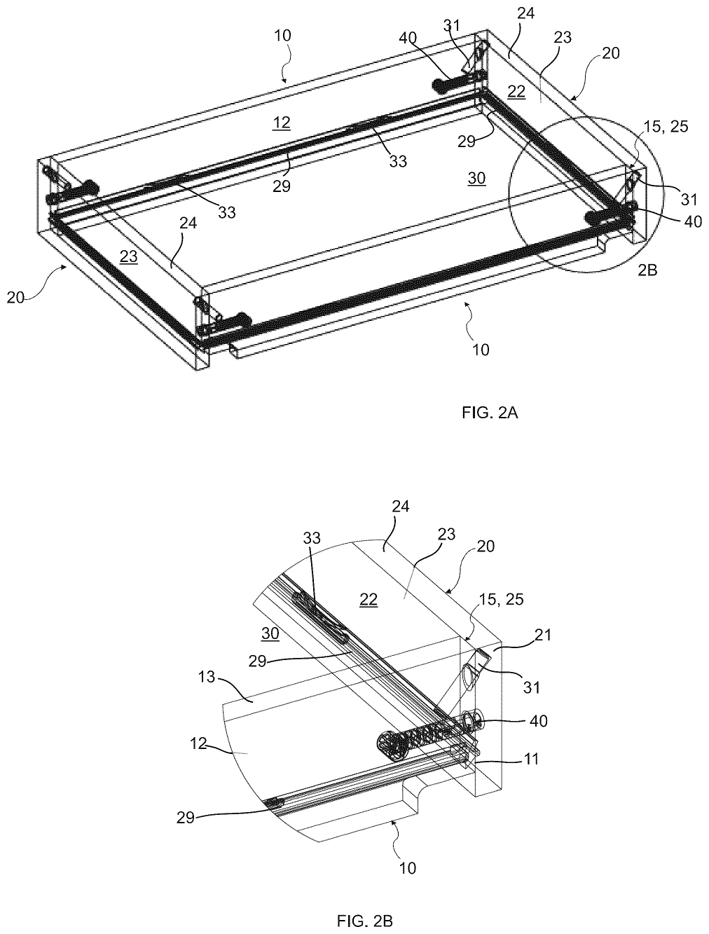

One of the second joinery element surface 22, or the third edge surface 21, whichever comprises the second attachment surface 25, which in FIGS. 1A-1D is the joinery element surface 22, is provided with a joinery element groove 29, which is shown in, e.g., FIGS. 2A-2D.

Any surface of the respective joinery elements 10, 20, such as any planar surface, may constitute an attaching surface 15, 25, although for shipping purposes, e.g., for enabling flat packages, the first attaching surface 15 may be (or may be a part of) an edge surface.

The joinery product comprises two first joinery elements 10 and two second joinery element 20. The first joinery elements 10 are arranged opposite one another and the two second joinery element 20 are arranged opposite one another. Thus, one first joinery element 10 is arranged adjacent two second joinery elements 20, and one second joinery element 20 is arranged adjacent two first joinery elements 10. The two first joinery elements 10 and the two second joinery element 20 are arranged in a frame-like manner when attached to each other to form the joinery product.

The second edge surface 12 of the respective first joinery elements 10 are also provided with a joinery element groove 29, as shown, e.g., in FIGS. 2A-2D.

The second edge surfaces 12 of the respective first joinery elements 10 are facing each other when in the mounted frame-like manner.

The joinery element groove 29 is provided in the surface 22, 21, 24 which comprises the second attaching surface 25 and a surface of the first joinery element 10 which is adjacent to said surface 22, 21, 24 in the second joinery element 20 in the assembled state of the first 10 and second 20 joinery elements.

The joinery element grooves 29 of the first 10 and second 20 joinery elements form a coherent groove along the inner circumference of the joinery product when the first 10 and second 20 joinery elements are attached to each other in the frame-like manner.

The height H of the joinery product, corresponding to the length of the longer side of the third edge surface 21, is preferably 30-120 mm, such as 50-100 mm, such as approximately 90 mm.

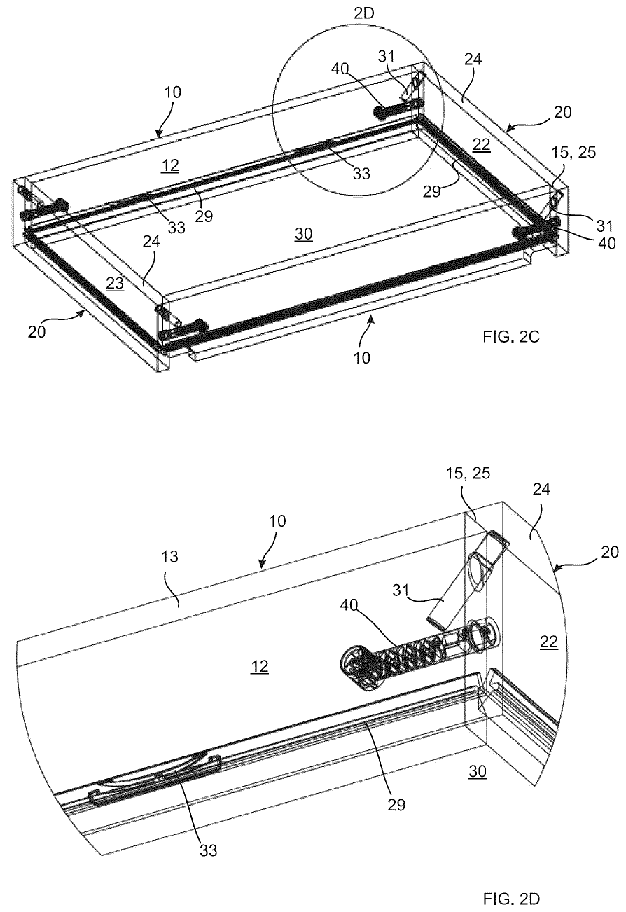

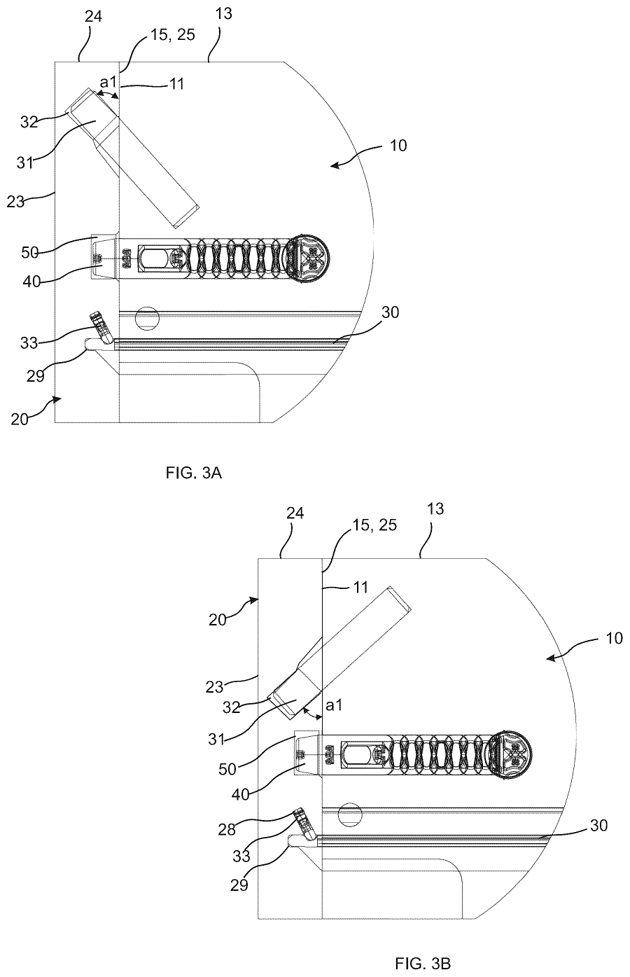

Referring to FIGS. 2-4, the joinery product further comprises a mechanical locking device 60. In FIGS. 2-3, the joinery elements 10, 20 and the mechanical locking device 60 are shown in an assembled state of the joinery product. In FIG. 4, the joinery elements 10, 20 and the mechanical locking device 60 are shown in an unassembled state of the joinery product.

The mechanical locking device 60 comprises a dowel 31 protruding at a dowel angle a1 from the first attaching surface 15 of the first joinery element 10. The mechanical locking device 60 further comprises a compressible locking element 40 positioned partially in a first joinery element recess 41 in the first attaching surface 15. The compressible locking element 40 is partially protruding from the first attaching surface 15 in its uncompressed state. The uncompressed state is, e.g., a locked state.

The mechanical locking device 60 further comprises an insertion recess 32 arranged in the second attaching surface 25. The insertion recess 32 extends into the second joinery element 20. The insertion recess 32 extends into the second attaching surface 25 of the second joinery element 20 by an angle approximately corresponding to the dowel angle a1. The insertion recess 32 is configured to receive the dowel 31 when the first 10 and second 20 joinery elements are attached to one another. When the dowel 31 extends into the insertion recess 32, it interacts with an inner circumferential surface of the insertion recess 32. The cooperation between the dowel 31 and the insertion recess 32 counteracts displacement of the first joinery element 10 relative to the second joinery element 20 along the normal direction N1 of the first attaching surface 15.

The mechanical locking device 60 further comprises a locking recess 50 arranged in the second attaching surface 25. The locking recess 50 extends into the second joinery element 20. The locking recess 50 extends into the second joinery element 20 in the normal direction N2 of the second attaching surface 25. The locking recess 50 is configured to receive the compressible locking element 40 when the first 10 and second 20 joinery elements are attached to one another.

The locking recess 50 comprises a locking surface 51. The locking surface 51 is a circumferential surface of the locking recess 50. When the compressible locking element 40 extends into the locking recess, the locking surface 51 is configured to interact with the compressible locking element 40 such that the first joinery element 10 is locked relative the second joinery element 20 in directions in the plane of the first attaching surface 15.

The third joinery element 30 is arranged in the joinery element grooves 29 of the respective joinery elements 10, 20. A circumferential edge portion of the third joinery element 30 is configured to be received by the joinery element grooves 29.

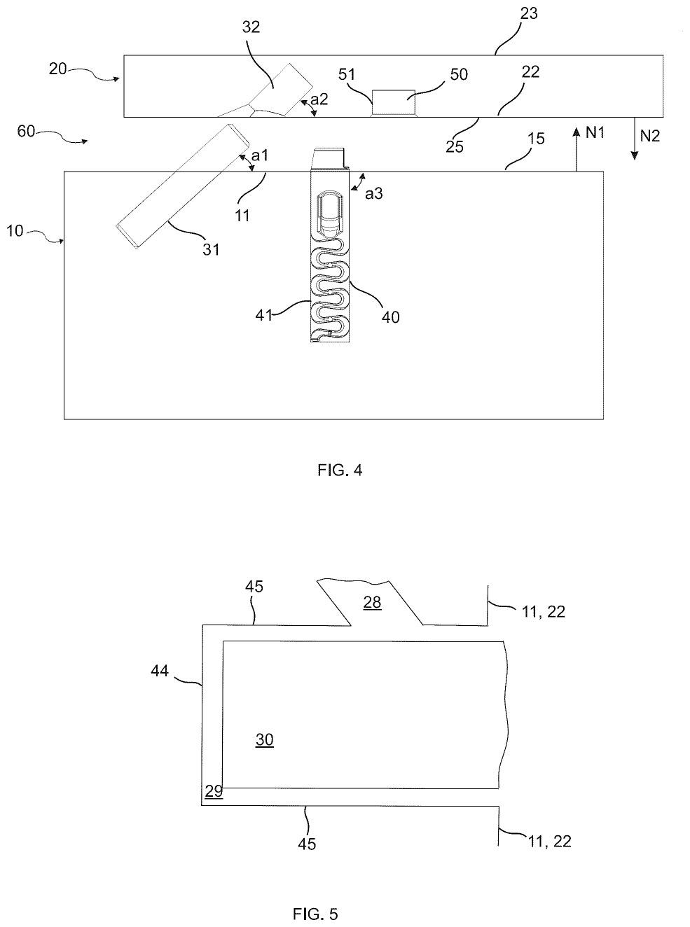

As shown in FIG. 5, each joinery element groove 29 comprises a bottom surface 44 and upper and lower side surfaces 45.

In one embodiment, the joinery element groove 29 is configured to receive a locking member 33, such as a bar or a tongue, configured to lock the third joinery element 30 against the side 45 and bottom 45 surfaces of the joinery element groove 29. Preferably, the locking member 33 is received in a locking member groove 28 provided in the joinery element groove 29. The locking member 33, such as a bar or a tongue, may have a longitudinal shape. A longitudinal length of the locking member may be parallel or essentially parallel with a longitudinal length of the locking member groove 28. Further embodiments of the locking member 33 will be further explained below.

In one embodiment, the locking member comprises a flexible tongue 33 arranged in the locking member groove 28. The locking member groove 28 is preferably provided in the side surface 45 of the joinery element groove 29, as shown, e.g., in FIGS. 3A, 3B, and 5. The flexible tongue 33 may cooperate with a tongue groove 27 in the third joinery element, as shown, e.g., in FIGS. 10A-F, for locking the first 10 and/or second 20 joinery elements to the third joinery element 30.

One or more of the tongue groove 27, the locking member groove 28, and the joinery element groove 29 may be formed by mechanically cutting, such as milling.

In one embodiment, the third joinery element 30 is locked against the side surfaces 45 and the bottom surface 44 of the joinery element groove 29 by complementary shapes or by friction.

When the third joinery element 30 is locked in the joinery element groove 29, it is configured to interact with the surfaces 44, 45 of the joinery element groove 29 to counteract rotational displacement of the first joinery element 10 relative to the second joinery element 20 in directions in the plane of the first attaching surface 15.

The cooperation between the dowel 31 and the insertion recess 32, the locking surface 51 and the compressible locking element 40, the third joinery element 30 and the surfaces 44, 45 of the joinery element groove 29 results in a joinery product requiring only one dowel 31 per interface between two joinery elements. For example, the mechanical locking device 60 comprises only one dowel 31 at the first attaching surface 15.

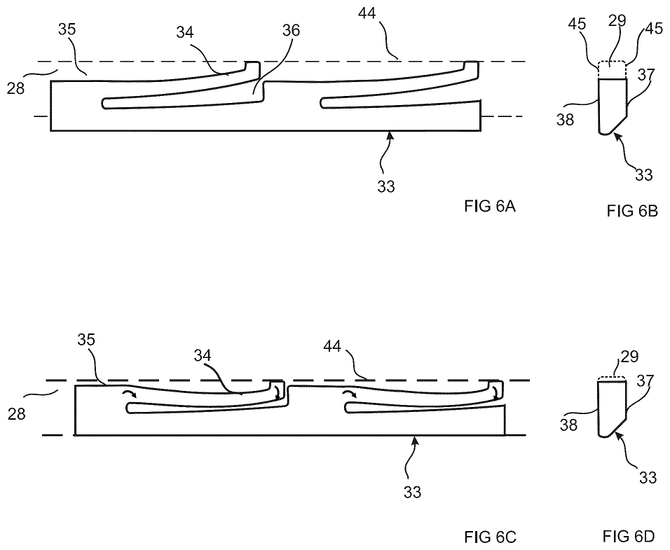

FIGS. 6A-6D show a locking member 33 in the form of a flexible tongue according to one embodiment. The flexible tongue 33 has a longitudinal or elongate shape.

The flexible tongue 33 is configured to be displaceably arranged in the joinery element groove 29, preferably in the locking member groove 28 provided in the joinery groove 29. The length direction of the flexible tongue 33 is configured to be parallel to a length direction of the of the joinery element groove 29 and the locking element groove 28, when the flexible tongue 33 is arranged in the locking element groove 28.

FIGS. 6A-6B show the flexible tongue 33 in a locked position and FIGS. 6C-6D show the flexible tongue 33 during assembly of the joinery product. FIG. 6B shows a cross section of the flexible tongue 33 in FIG. 6A. FIG. 6D shows a cross section of the flexible tongue 33 in FIG. 6C. The flexible tongue 33 comprises bendable protruding portions 34. A recess 36 is preferably arranged at each bendable protruding portion 34 of the flexible tongue 33. A space 35 is provided between the flexible tongue 30 and the bottom surface of the locking member groove 28.

FIG. 6C shows that the flexible tongue 33 is pushed into the locking member groove 28 during assembly of the joinery product. The flexible tongue 33 is configured to be compressed towards a bottom surface of the locking member groove 28 during assembly of the joinery product. The flexible tongue 33 is configured to spring back toward its initial position when the elements to be joined have reached a locked position.

The flexible tongue 33 may have a first displacement surface 37 and an opposite second displacement surface 38, configured to be displaced along the respective side surfaces 45 of the locking member groove 28.

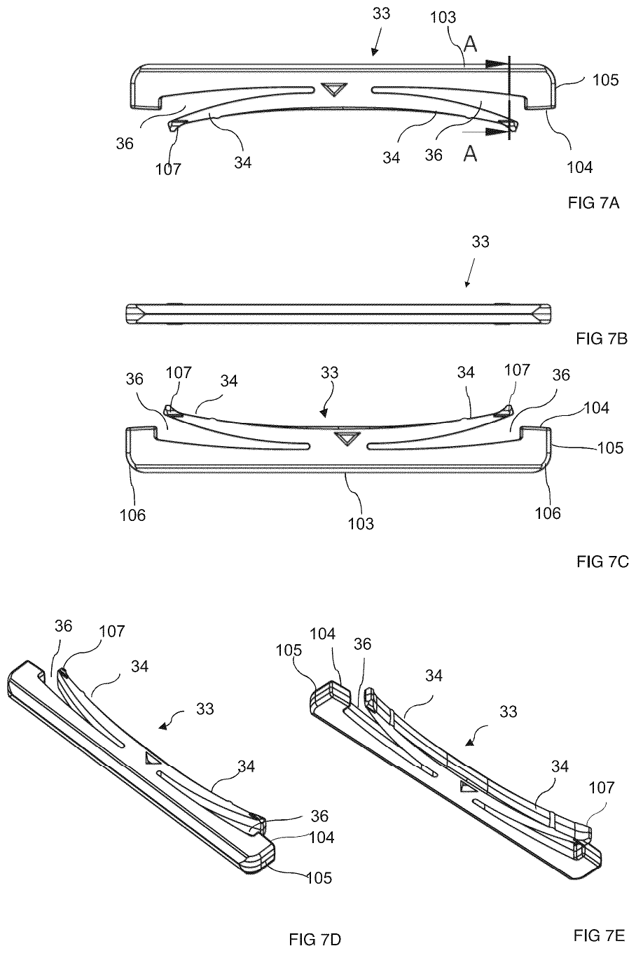

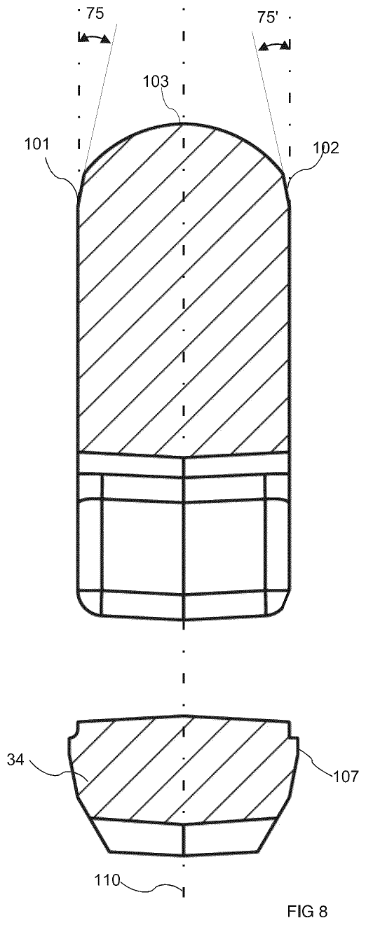

Embodiments of the flexible tongue 33 configured to be inserted into the locking member groove 28 are shown in FIGS. 7A-7E and 8.

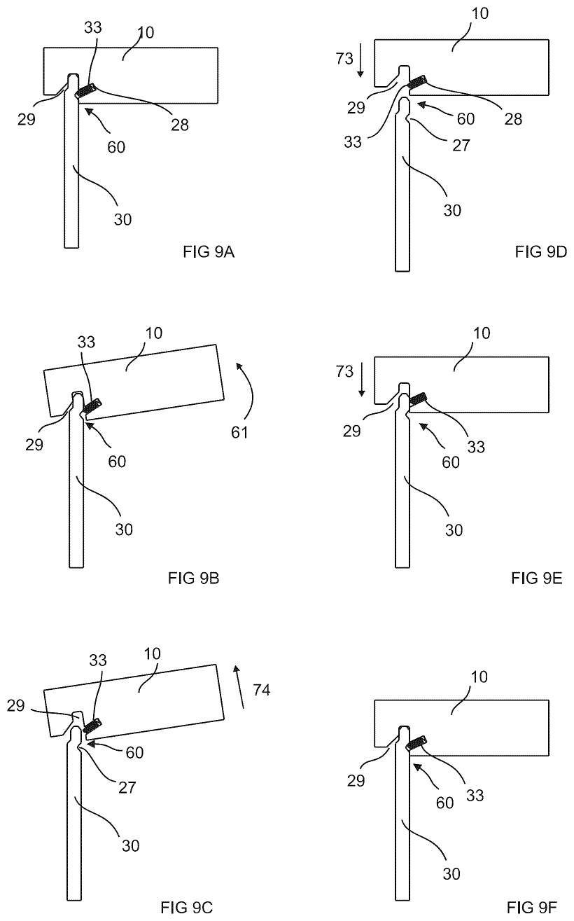

FIGS. 7A-E show different views of an embodiment of a flexible tongue. FIG. 8-9B show an enlargement of a cross section A-A of the embodiment shown in FIGS. 7A-7E.

FIG. 8 shows enlargements of the cross section A-A indicated FIG. 7A. The cross section A-A extends through the protruding friction element 107.

The flexible tongue 33 comprises a first locking surface 101 and a second locking surface 102. The first locking surface 101 is configured to cooperate with the locking member groove 28 for locking the third joinery element 30 to the first or second joinery element 10, 20, respectively, in a first direction when the flexible tongue 33 is positioned in the locking member recess 28 in a first orientation.

The second locking surface 102 of the flexible tongue 4 is configured to cooperate with the locking member groove 28 for locking the third joinery element 30 to the first or second joinery element 10, 20, respectively, in a first direction when the flexible tongue 33 is positioned in the joinery element groove 28 in a second orientation.

The first locking surface 101 and the second locking surface 102 may be essentially symmetrically positioned on the flexible tongue 33.

The first locking surface 101 and the second locking surface 102 may converge towards each other.

An angle 75 between the first locking surface 101 and a line parallel with a centreline 110 of the flexible tongue in the cross section may be within a range of about 2° to about 45°, such as about 5 to about 20°, such as about 8 to about 15°, such as about 11.

An angle 75′ between the second locking surface 102 and a line parallel with a centreline 110 of the flexible tongue in the cross section may be within a range of about 2° to about 45°, such as about 5 to about 20°, such as about 8 to about 15°, such as about 11.

The flexible tongue 33 may comprise a guiding surface 103 configured to cooperate with the first or second joinery element 10, 20, during a displacement of the first or second joinery element 10, 20 relative the third joinery element 30.

The guiding surface 103 may, in a first end, be connected to the first locking surface 101 and may, in a second end, be connected to the second locking surface 102.

The guiding surface 103 may have a curved shape. The guiding surface 103 may have the shape of a circular segment. The curved shape of the guiding surface 103 may have a radius between the first 101 and second 102 locking surfaces within the range of about 0.5 mm to about 3 mm, preferably within the range of 1 mm to 2 mm, or preferably about 1.5 mm.

The flexible tongue 33 may have a thickness T and the curved shape of the guiding surface 103 may have a radius between the first 101 and second 102 locking surfaces within the range of about 0.2×T to 1.2×T, or about 0.4×T to about 0.8×T, or 0.6×T.

The guiding surface 103 may be configured to cooperate with a curved shape surface of a disassembling tool, wherein the disassembling tool may have a circular cross section.

The guiding surface 103 may be configured to cooperate with a disassembling tool, wherein the disassembling tool may have a triangular cross section.

The flexible tongue 33 may have a support surface 104 positioned opposite to the guiding surface 103, wherein the support surface 104 may have a curved shape with a radius within the range of about 25 mm to about 50 mm, preferably within the range of 30 mm to 45 mm, or preferably about 37 mm.

The curved shape of the support surface 104 may have a radius R which is smaller or the same as a radius of a bottom surface 44 of the joinery element groove 29.

The flexible tongue 33 may comprise a bendable portion 34, preferably a first bendable portion and a second bendable portion. The flexible tongue 33 preferably comprises a recess 36 at each of said bendable portions 34. An advantage with this embodiment of the flexible tongue is that a stronger spring force may be obtained which may provide a stronger locking.

The flexible tongue 33 may comprise a side portion 106, with a beveled or rounded shape. The side portion 106 may be configured to guide the disassembling tool during disassembling.

The flexible tongue 33 may comprise a protruding friction element 107 on the first and/or second bendable portion 34. The size of the friction element 107 does not have to be the same on the first and second bendable portions 34, but the size of the friction element 107 may be bigger on one side, which facilitates the movement of the flexible tongue 33 sideways in the locking member groove 28.

FIGS. 9A-9C show an embodiment of a method to disassemble an embodiment of the present disclosure. FIGS. 9D-9F show an embodiment of a method to assemble the embodiment shown in FIGS. 9A-9C.

FIG. 9A shows the first joinery element 10 and the third joinery element 30 in a locked position.

FIG. 9B shows that the first joinery element 10 is angled upwards by an angling motion 61, wherein an angle between the first joinery element 10 and the third joinery element 30 is increased and the flexible tongue 33 moves out of the locking member groove 28 of the first joinery element 10.

FIG. 9C shows a displacement 74 of the first joinery element 10 in a direction which may be diagonally upward. The angle of the displacement depends on the configuration of the mechanical locking device 60. The displacement and the angling motion may be performed simultaneous. The displacement 74 releases the first joinery element 10 from the third joinery element 30.

FIG. 9D shows that the first joinery element 10 is displaced 73 relative the third joinery element 30 in a direction which is essentially parallel to a plane of the third joinery element 30.

FIG. 9E shows that flexible tongue 33 is displaced and compressed into the locking member groove 28. The flexible tongue 33 springs at least partly back when the first joinery element 10 and the third joinery element 30 has reached a final locked position, as shown in FIG. 9F. The first joinery element 10 and the third joinery element 30 could also be assembled by reversing the movements shown in FIGS. 10A-10C. The assembly/disassembly of the second joinery element 20 and the third joinery element 30 is performed in the same manner.

The joinery product fulfils the test requirements of standards EN 14749 5.3.7.1 (Slam open of extension elements) and EN 14749 5.3.7.2 (Strength test of extension elements). These tests refer to test a drawer mounted on drawer rails. The tests were, as prescribed in these standards, performed according to EN 16122.

A core material of the first, second and third joinery elements in the embodiments above preferably comprises a wood fibre based board, such as a HDF, MDF, plywood, solid wood or particleboard, a reinforced plastic board, or a wood fibre composite board. The core material may be provided with a decorative layer.

As used herein, the singular forms “a”, “an” and “the” are intended to include the plural forms as well, unless expressly stated otherwise. Thus, the indefinite articles “a” and “an,” as used herein in the specification and in the claims, unless clearly indicated to the contrary, should be understood to mean “at least one”.

It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While several embodiments of the present disclosure have been described and illustrated herein, those of ordinary skill in the art will readily envision a variety of other members and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching of the present disclosure is/are used.

1. A joinery product comprising:
a first joinery element having a first edge surface, a second edge surface, and a first joinery element surface, wherein said second edge surface is adjacent to said first edge surface, and wherein a first attaching surface is at least part of said first edge surface or said second edge surface;
a second joinery element having a second joinery element surface, a third joinery element surface, a third edge surface, and a fourth edge surface, wherein a second attaching surface is at least part of said second joinery element surface, the third edge surface or the fourth edge surface, wherein the first attaching surface faces and is configured to be locked with the second attaching surface in a locked position;
a third joinery element positioned in a joinery element groove formed in the surface which comprises the second attaching surface and a thereto adjacent surface of the first joinery element, and
a mechanical locking device comprising:
a dowel protruding at a dowel angle from the first attaching surface;
an insertion recess extending into the second attaching surface, said insertion recess being configured to receive said dowel;
a compressible locking element positioned partially in a first joinery element recess in the first attaching surface, and
a locking recess in the second attaching surface being configured to receive said compressible locking element,
wherein a locking surface of said locking recess in the locked position is configured to cooperate with the compressible locking element for locking of the first joinery element relative to the second joinery element in directions in the plane of the first attaching surface,
wherein the inclination of said dowel counteracts displacement of the first joinery element relative to the second joinery element along the normal direction of the first attaching surface, and
a locking member arranged in the joinery element groove,
wherein the third joinery element is locked in the joinery element groove by the locking member to counteract rotational displacement of the first joinery element relative to the second joinery element in directions in the plane of the first attaching surface.

2. The joinery product according to claim 1, wherein the joinery element groove comprises a locking member groove configured to house the locking member.

3. The joinery product according to claim 1, wherein the locking member is an elongate flexible tongue.

4. The joinery product according to claim 1, wherein the locking member is arranged in a locking member groove provided in the joinery element groove.

5. The joinery product according to claim 1, wherein the mechanical locking device comprises only one dowel at the first attaching surface.

6. The joinery product according to claim 1, wherein the compressible locking element is arranged closer to the third joinery element than the dowel.

7. The joinery product according to claim 1, wherein the dowel is arranged further from the third joinery element than the compressible locking element.

8. The joinery product according to claim 1, wherein the compressible locking element in an uncompressed state partially protrudes from the first attaching surface.

9. The joinery product according to claim 1, wherein the compressible locking element, in a compressed state, is configured to be substantially accommodated within the first joinery element recess.

10. The joinery product according to claim 1, wherein the compressible locking element is, in the locked position, configured to be displaced partly into the locking recess.

11. The joinery product according to claim 1, wherein said compressible locking element and said dowel are positioned on a straight line extending in a longitudinal extent of the first attaching surface.

12. The joinery product according to claim 1, wherein said compressible locking element and said dowel are arranged at different perpendicular distances from a straight line extending along a longitudinal extent of the first attaching surface, said distance being less than 30 mm.

13. The joinery product according to claim 1, wherein the dowel angle of the dowel relative the first attaching surface is in a range of 20°-75°.

14. The joinery product according to claim 1, wherein said insertion recess extends into the second attaching surface at a recess angle from the second attaching surface and the difference between the dowel angle and the recess angle is in a range of 0° to 6°.

15. The joinery product according to claim 1, wherein a side of the joinery element recess, being adjacent to the first attaching surface, extends at a joinery element recess angle relative the first attaching surface.

16. The joinery product according to claim 15, wherein the joinery element recess angle is in a range of 70°-110°.

17. The joinery product according to claim 15, wherein a difference between the dowel angle and the joinery element recess angle is 10°-100°.

18. The joinery product according to claim 1, wherein locking member has a longitudinal shape with a length direction parallel to a length direction of the joinery element groove.

19. The joinery product according to claim 3, wherein the locking member, in the form of a flexible tongue, is configured to be compressed towards a bottom surface of the locking member groove.

20. The joinery product according to claim 3, wherein the flexible tongue is made of a polymer material.

21. The joinery product according to claim 3, wherein the joinery product is one of a cupboard or a drawer, optionally a kitchen drawer.

22. The joinery product according to claim 1, wherein a height of the joinery product, corresponding to the length of the longer side of the third edge surface, is 30 mm, such as 50 mm, such as approximately 90 mm.

23. The joinery product according to claim 1, wherein a core material of one or more of the first, second and third joinery elements comprises a wood fibre based board, optionally one of HDF, MDF, plywood, solid wood or particleboard, a reinforced plastic board, and a wood fibre composite board.

24. The joinery product according to claim 23, wherein the core material is provided with a decorative layer.
